(19) United States
(12) Patent Application Publication
(10) Pub. No.: US 2003/0023718 A1
(43) Pub. Date: Jan. 30, 2003

(54) System and method for tracking updates in a network site

(76) Inventor: Donald X. Smith II, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/916,830

(22) Filed: Jul. 26, 2001

(51) Int. Cl. G06F 15/16; G06F 15/173

(52) U.S. Cl. 709/224; 709/203

(57) ABSTRACT

Various systems and methods are provided for tracking updates that occur in predefined network sites such as, for example, web sites available on the World Wide Web. In one embodiment, a network update tracking system is provided in a server. This network update tracking system includes a processor circuit having a processor and a memory, and update detection logic stored on the memory and executable by the processor. The update detection logic comprises logic that detects a number of updates in a corresponding number of network sites, and logic that generates an update report to be sent to a client via a network, the update report listing at least one of the updates.

### TECHNICAL FIELD

The present invention is generally related to the field of network site access, and, more particularly, is related to a system and method for tracking updates in a network site.

### BACKGROUND OF THE INVENTION

The advent of the information age and the creation of the Internet has provided new access to information on an unprecedented scale. Sites can now be found on the Internet covering a seemingly unlimited range of topics, depending upon the interests and motivations of those who create and maintain the sites. Now virtually anyone can find various sites on the Internet that are devoted to subjects that hold their interests. For example, assuming one was interested in the American Civil War, there are several sites on the Internet that display information regarding this subject.

While the information available on sites of interest is welcome to many, it may be difficult to keep up with updates that occur to multiple network sites. In the typical case, a site maintained on the Internet is altered by one or more individuals in charge of the content thereof. In many situations, the specific time and date of any updates applied to a particular network site is unpredictable. Often, such updates occur when those who maintain the sites are able to perform the update. Assuming that an individual follows a number of network sites that provide information of particular interest, then it can be a tedious task to periodically access the Internet or other network and download all of the sites of interest to see if any updates have occurred.

This task can be especially tedious if there were no updates in a particular site as the time taken to access this site is wasted. Consequently, it is often the case individuals may put off downloading such sites to check for updates or may be discouraged from downloading the sites altogether. Unfortunately, this means that the information offered on such sites does not get to those who want it in a timely manner if at all.

### SUMMARY OF THE INVENTION

In light of the foregoing, the present invention provides for various systems and methods for tracking updates that occur in a network site. At least one update in a network site in computer system coupled to a network is detected and an update report is generated in the computer system, the update report identifying at least one update. The update report is then presented to a user.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a data communications network including an update detection server, a second server, and a client according to an aspect of the present invention;

FIG. 2 is a graphical user interface displayed by the client of FIG. 1;

FIG. 3 is an association chart depicting associations between fields in a site update database in the update detection server of FIG. 1;

FIG. 4 is a flow chart of a first update detection system executed on the update detection server of FIG. 1;

FIG. 5 is an association chart depicting associations between fields in a site update database in the client of FIG. 1; and

FIG. 6 is a flow chart of a second update detection system executed in the client of FIG. 1.

### DETAILED DESCRIPTION OF THE INVENTION

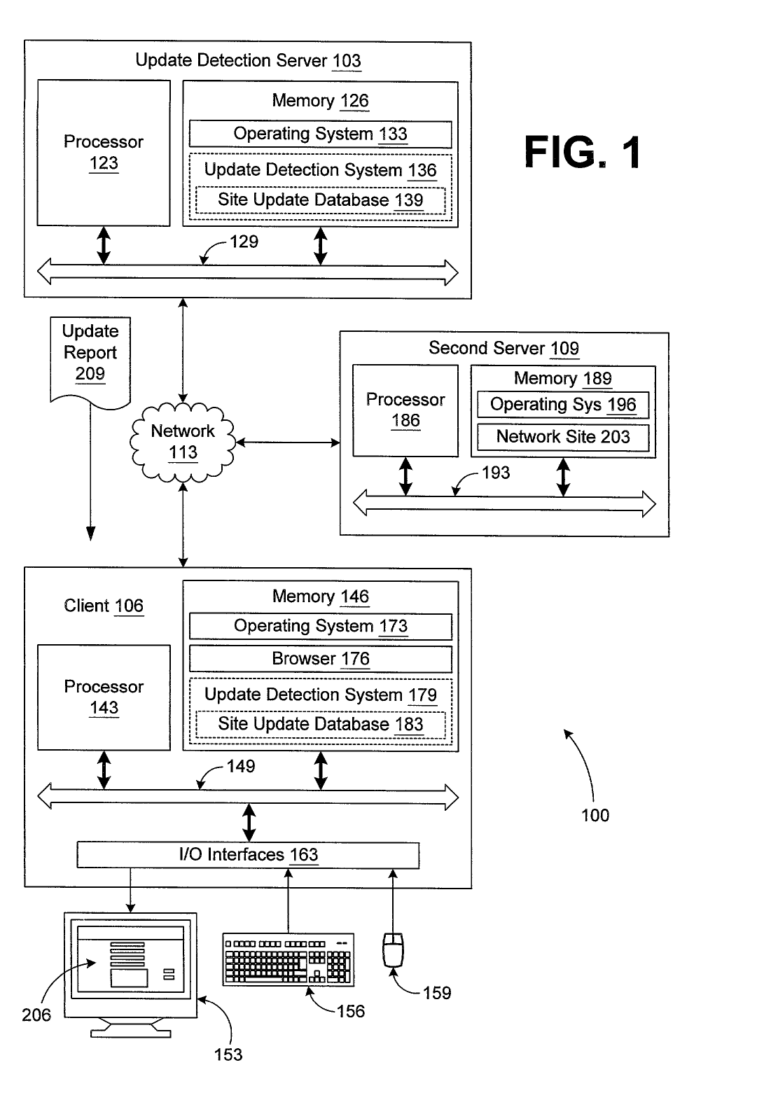

With reference to FIG. 1, shown is a data communications network 100 according to an aspect of the present invention. The data communications network 100 includes an update detection server 103, a client 106, and a second server 109. Note, that the data communications network 100 may include multiple other servers and clients as is generally known by those with ordinary skill in the art. The update detection server 103, client 106, and second server 109 are all coupled to a network 113. The network 113 may be, for example, the Internet, wide area networks (WANs), local area networks, or other suitable networks, etc., or any combination of two or more such networks.

According to the present invention, the update detection server 103 alerts users of any updates of made to network accessible sites (“network sites”) such as web sites on the World Wide Web stored on servers such as the second server 109. Before the discussion of the particular operation and functional aspects of the present invention, a more detailed description of the various components in the data communications network 100 is first provided.

In this regard, the update detection server 103 may comprise, for example, a computer system or other device with like capability having a processor circuit that includes a processor 123 and a memory 126, both of which are coupled to a local interface 129. The local interface 129 may comprise, for example, a data bus with an accompanying control/address bus as is generally known by those with ordinary skill in the art. Stored on the memory 126 and executable by the processor 123 are an operating system 133 and an update detection system 136. The update detection system 136 includes a site update database 139 that is accessed and manipulated by the update detection system 136 as will be described.

The client 106 may also comprise, for example, a computer system or other device with like capability having a processor circuit with a processor 143 and a memory 146, both of which are coupled to a local interface 149. The local interface 149 may comprise, for example, a data bus with an accompanying control/address bus as is generally known by those with ordinary skill in the art. The client 106 also includes various peripheral devices such as a display device 153, a keyboard 156, and a mouse 159 as shown. The display device 153, keyboard 156, and the mouse 159 are all coupled to the local interface 149 through various input/output interfaces 163. The input/output interfaces 163 may comprise, for example, various input and output cards are generally known by those with ordinary skill in the art. In addition, the client 106 may include other peripheral devices such as, for example, keypads, touch pads, touch screens, microphones, scanners, joysticks, or one or more push buttons, indicator lights, speakers, printers, etc. The display device 153 may be, for example, a cathode ray tube (CRT), a liquid crystal display screen, a gas plasma-based flat panel display, etc.

Stored on the memory 146 and is executable by the processor 143 is an operating system 173, a browser 176, and an update detection system 179 that includes a sight update database 183. The update detection system 179 is executed on the client 106 as an additional embodiment of the present invention as will be discussed.

The second server 109 may comprise, for example, a computer system or other device with like capability having a processor circuit with a processor circuit having a processor 186 and a memory 189, both of which are coupled to a local interface 193. The local interface 193 may comprise, for example, a data bus with an accompanying control/address bus as is generally known by those with ordinary skill in the art. Stored on the memory 189 and executable by the processor 186 are an operating system 196 and one or more network sites 203. The network site 203 may comprise, for example, a web server and associated web sites as is generally known by those with ordinary skill in the art. The second server 109 provides one example of the multitude of servers that are coupled to the network 113.

The memories 126, 146, and 189 may include both volatile and nonvolatile memory components. Volatile components are those that do not retain data values upon loss of power. Nonvolatile components are those that retain data upon a loss of power. Thus, the memories 126,146, and 189 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

Also, each of the processors 123,143, and 186 may represent multiple processors and each of the memories 126,146, and 189 may represent multiple memories that operate in parallel processing circuits, respectively. In such a case, the local interfaces 129,149, and 193 may be an appropriate network that facilitates communication between any two of the multiple processors or between any processor and any of the memories, etc. The local interfaces 129,149, and 193 may facilitate memory to memory communication as well. The processors 123,143, and 186 may be electrical or optical in nature.

In addition, the operating systems 133,173, and 196 are executed to control the allocation and usage of hardware resources in the update detection server 103, client 106, and the second server 109. Specifically, the operating systems 133,173, and 196 control the allocation and usage of the memories 126,146, and 189, processing time, and the peripheral devices as well as performing other functionality in the update detection server 103, client 106, and the second server 109, respectively. In this manner, the operating systems 133, 173, and 196 serve as the foundation on which applications depend as is generally known by those with ordinary skill in the art.

Next a discussion of the operation of the update detection systems 136 and 179 are provided. First, attention is drawn to the operation of the update detection system 136 in the update detection server 103. In this embodiment of the present invention, the update detection system 136 employs a client/server model of operation to track updates made to multiple network sites 203 for multiple clients 106. To determine whether a particular network site 203 has been updated, the update detection system 136 generates a measure of the content of the particular network site 203 and compares that measure with a previously obtained content measure for the same network site 203 at an earlier time. By comparing these content measures, the update detection system 136 can determine whether any changes have occurred to a particular network site 203.

To begin, a particular client 106 sets up an account with the update detection system 136. This may be done, for example, using the browser 176 to access network pages that are generated by the update detection system 136 to set up such an account. In this manner, records are kept that includes such information as the user's billing information and other data. The user may also identify one or more network sites 203 that are to be monitored by the update detection system 136. Also, the user should identify one or more comparison events that are employed by the update detection system 136 to determine when it should check a particular network site 203 for updates. A comparison events are employed as triggers that cause a comparison to be performed between a measure of the content of a particular network site 203 with a prior stored measure of the same content. The comparison event could be any event including periodic events such as, for example, the occurrence of a specific time of day, day of the week, or day of the month when the network site 203 is to be checked in a periodically as such. The comparison events may occur periodically, non-periodically, randomly, or in another order.

Alternatively, the comparison event may be defined in some other manner such as, for example, upon an occurrence of a predefined political or financial event in the world. Such comparison events should be capable of being quantified in a form recognizable by the update detection system 136 before they can be used as should be apparent to one with ordinary skill in the art. To provide a specific example, a user may wish to obtain an update of a network site 203 for a particular company upon an occurrence of a desired change in that company's stock price. Thus, the company's stock price should be quantified in a digital form available to the update detection system 136 so that the corresponding comparison event may be employed. Virtually any type of event can be employed as a comparison event provided that it can be quantified so that the update detection system 136 can detect an occurrence of the event itself.

Upon an occurrence of a particular comparison event, the update detection system 136 then proceeds to determine whether the one or more network sites 203 associated with the comparison event have been updated since they were last checked. This is done by performing a comparison of the network site 203 in its current state with its state as it was checked at a previous time.

There are several ways that such a comparison can be performed. In one approach, the entire network site 203 may be stored when checked and subsequent downloads of the entire network site 203 may be compared to the stored version until a change is detected. Another approach may employ the update dates associated with various network sites 203. In particular, many network sites 203 are programmed to maintain an update date within the memory 189 that can be provided to the update detection system 136 when the update detection system accesses the particular network site 203. This update date may then be compared with a previous update date stored in the memory 126 by the update detection system 136 when it examined the particular network site 203 on a previous occasion. If the update date has changed, then the update detection system 136 knows that the network site 203 was updated.

Alternatively, the update detection system 136 may download the network site 203 to generate a checksum therefrom that is compared with a previously generated and stored checksum of the same network site 203. Such checksums may be generated in any one of a number of ways. For example, the number of characters displayed in the network site 203 may be examined and stored. Also, a mathematical vector representing an image of the network site 203 may be stored for image comparison. Such a mathematical vector may be generated from the pixels that make up the network site 203 or from a subset of the pixels that make up the network site 203 as is generally known by those with ordinary skill in the art. In addition, text comparisons may be performed to detect differences therein or, a comparison of the markup of the network site 203 may be made in the cases that the network site 203 has been created using various markup languages such as, for example, Hyper Text Markup Language (HTML) or Extensible Markup Language (XML) or other mark up language.

Note that in generating the checksum or comparing various versions of network sites 203, etc., various approaches may concurrently be employed to ignore various portions of network sites 203 that may continually change. For example, the update detection system 136 may include a heuristic-based model that ignores changes made to various components of the network site 203. The various components may include, for example, portions of network sites 203 employed to display advertisements such as banner ads or other types of advertisement that may change frequently. Specifically, one such heuristic may include, for example, horizontal images of a particular size range and aspect ratio near the top of various pages in the network site 203 that are typically employed as banner advertisements, etc.

In another approach, the update detection system 136 may ignore various portions or elements that are tagged or otherwise identified in a predefined manner in a markup file that makes up the network site 203. For example, some network sites 203 may include markup files with tags, identifiers, or attributes that indicate that a particular element is an advertisement or other type of element that the user may not wish to be included in the comparison. For example, an element may include an attribute such as “content type=ADVERTISEMENT”, etc. In this respect, the tags, identifiers, or attributes that are to be ignored may be maintained in the site update database 139 and are identified and ignored during the comparison that occurs after a comparison event.

Once it is determined that a particular network site 203 has been altered, then the update detection system 136 generates an update report 209 that indicates that the network site 203 has changed. The update report 209 is then transmitted to one or more clients 106 that indicated that the particular network site 203 was to be monitored on their behalf. In this manner, the user of each of these clients 106 is informed when an update to a network site 203 monitored on their behalf has occurred.

The update report 209 may be transmitted to the client(s) 106 in one of a number of ways. For example, the update report 209 may be embodied in an electronic mail transmission to a predetermined address associated with the client 106. Alternatively, the update report 209 may be posted to a predefined network site that is transmitted to the client 106 when the user accesses such a network site using the browser 176. Also, the update report 209 may be faxed to a user or may be transmitted in some other manner.

The actual content of the update report 209 may be as simple as including the address of the network site 203 that has changed or may include a narrative or summary of the changes. Alternatively, a visual display such as a thumbnail or other display may be created and displayed on the display device 153. Also, the update report 209 may indicate any areas of change in a network site 203. For example, the portions of a network site 203 that have changed may be indicated in some manner, such as, for example, with highlighting or by generating a circle or box around the altered portions, etc.

In a second embodiment, the present invention provides for the update detection system 179 that implements a client based model to track several network sites 203 to detect any updates thereto for a single client 106. The update detection system 179 provides a simpler embodiment of the present invention in that the service is provided for a single client 106. A user may manipulate the graphical user interface 206 and the browser 176 to input any necessary comparison event and comparison type information into the update detection system 179. Alternatively, other types of user interfaces may be employed that do not use the browser 176. By manipulating the graphical user interface 206, the user may identify all network sites 203 that are to be checked for updates upon an occurrence of an associated comparison event. The update detection system 179 then performs the comparison of a particular network site 203 upon an occurrence of the comparison event in a similar manner to the update detection system 136 using any one of the approaches previously described. Thereafter, the update detection system 179 generates a report that is displayed to the client 106 on the display device 153 to inform them of any changes to any of the monitored network sites 203.

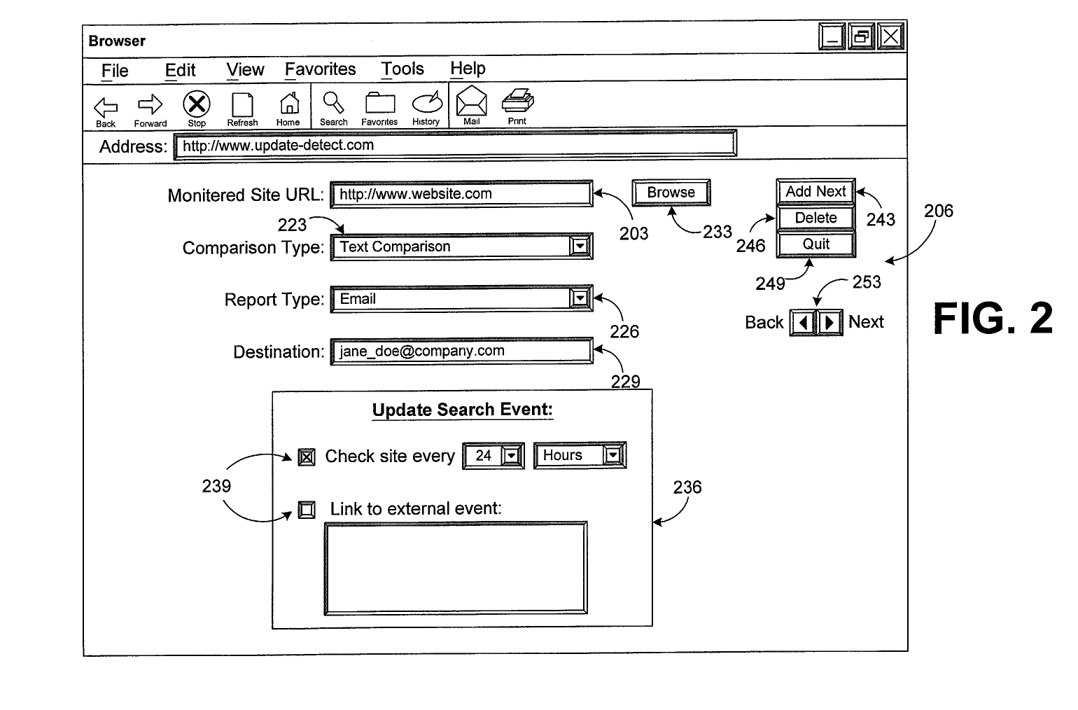

Turning to FIG. 2, shown is a depiction of a graphical user interface 206 according to an aspect of the present invention. The graphical user interface 206 may be employed to interface with the update detection system 136 (FIG. 1) executed on the update detection server 103 (FIG. 1) or the update detection system 179 (FIG. 1) executed on the client 106 (FIG. 1). As shown in FIG. 2, the graphical user interface 206 is generated by the browser 176 as is generally known by those with ordinary skill in the art, although it may be generated in another manner. To manipulate any of the components in the graphical user interface 206, a user may position a cursor over the appropriate component with the mouse 159 (FIG. 2) and press on a button on the mouse 159. This is referred to as “clicking” on a particular component. In addition, text may be entered using the keyboard as is generally known by those with ordinary skill in the art.

The graphical user interface 206 includes a field that allows the user to enter the uniform resource locator (URL) of the network site 203 that is to be monitored by the update detection system 136 or 179. Also, the graphical user interface 206 includes a field for a comparison type 223 that will be associated with the network site 203. The graphical user interface 206 also includes a field by which the user may select a report type 226 that indicates the format of the update report 209 (FIG. 1) that is generated by the update detection system 136 or 179.

The graphical user interface 206 also includes a field for the report destination 229 that indicates a destination on the network 113 for the update report 209. Note that the report type 226 and the report destination 229 may not be necessary in the context of the update detection system 179 as any updates that are reported to the user need not travel to a separate device via the network 113 as should be apparent.

The graphical user interface 206 also includes a browse button 233 that enables the user to browse for the network site 203 to obtain the URL therefore as is generally known by those with ordinary skill in the art.

In addition, the graphical user interface 206 depicts a comparison event box 236 within which are user interface components that may be employed by which the user to specify various comparison events 239. For example, the user may specify specific time periods as the comparison events 239 as shown. Alternatively, other types of comparison events may be indicated. Note that the components in the comparison event box 236 merely provide examples of such items, where other types of interfaces may be employed to specify other comparison events as should be apparent.

The graphical user interface 206 also includes “Add Next” button 243, a “Delete” button 246, and a “Quit” button 249. The “Add Next” button 243 may be clicked on by a user to add another network site 203 to be monitored by the update detection system 136 or 179. In particular, when the user clicks on the “Add Next” button 243, the various fields and components as depicted in FIG. 2 are shown as blank or with default information so that a user may specify a new network site 203 to be monitored. In addition, the “Delete” button 246 allows a user delete a particular network site 203 from the update detection system 136 or 179 so that network site 203 is no longer monitored.

The “Quit” button 249 may be clicked on by the user to send the information altered by the user back to the update detection system 136 or 179 to be included in the site update database 139 or 183, respectively. In addition, toggle buttons 253 are provided that enable the user to move between network sites 203 to display the various details associated with each network site 203 individually. Thus, by manipulating the various components of the graphical user interface 206, a user may specify each of the network sites 203 that are to be monitored by the update detection system 136 or 179. Specifically, the user may specify the network site 203, the comparison event 239 the comparison type to be performed 223, and the location and format of the update report 209 that is generated in the case of the update detection system 136.

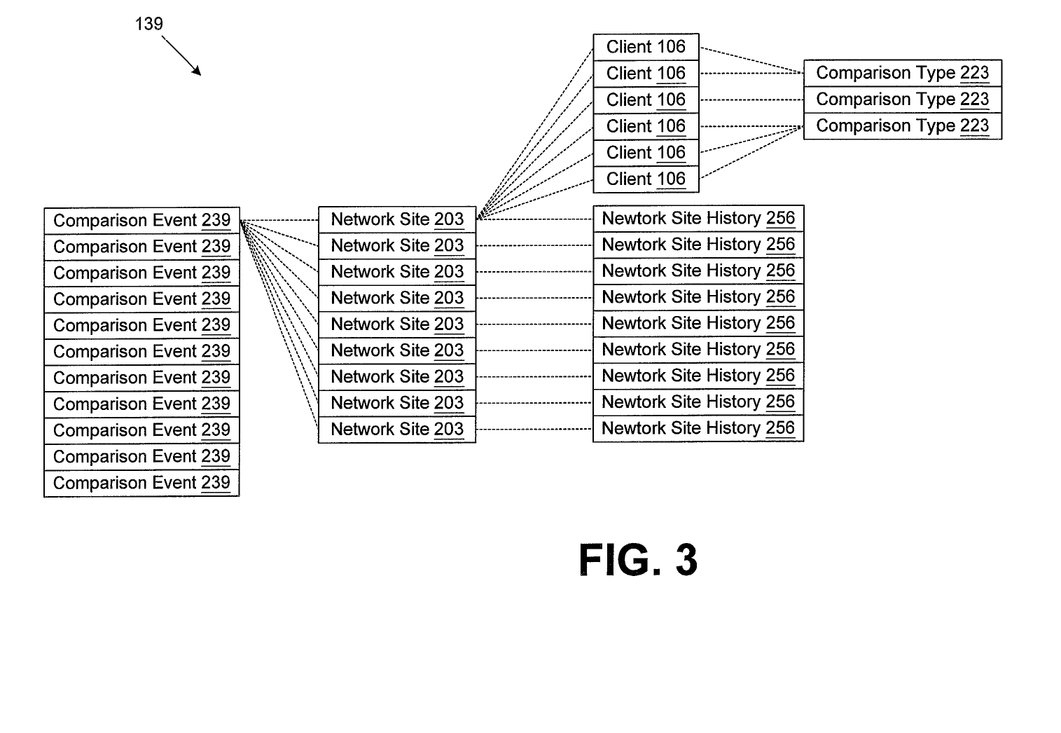

Reference is now made to FIG. 3 that depicts an association map of the various fields and data entities in the site update database 139 according to an aspect of the present invention. As shown, the site update database 139 may include multiple comparison events 239. Each comparison event 239 may be associated with a number of network sites 203. Likewise, each of the network sites 203 may be associated with a number of clients 106 and each of the clients 106 may be associated with a particular comparison type 223. Also, a network site history 256 is associated with each network site 203. Each of the network site histories 256 comprise a record of the times and the events when updates to a particular network site 203 were detected. Such information is stored, for example, so that a user may track the updates in a network site 203 to provide greater predictability as to when future changes might occur if possible. The previously mentioned associations are maintained in the site update database 139 in connection with the operation of the update detection system 136 as will be described.

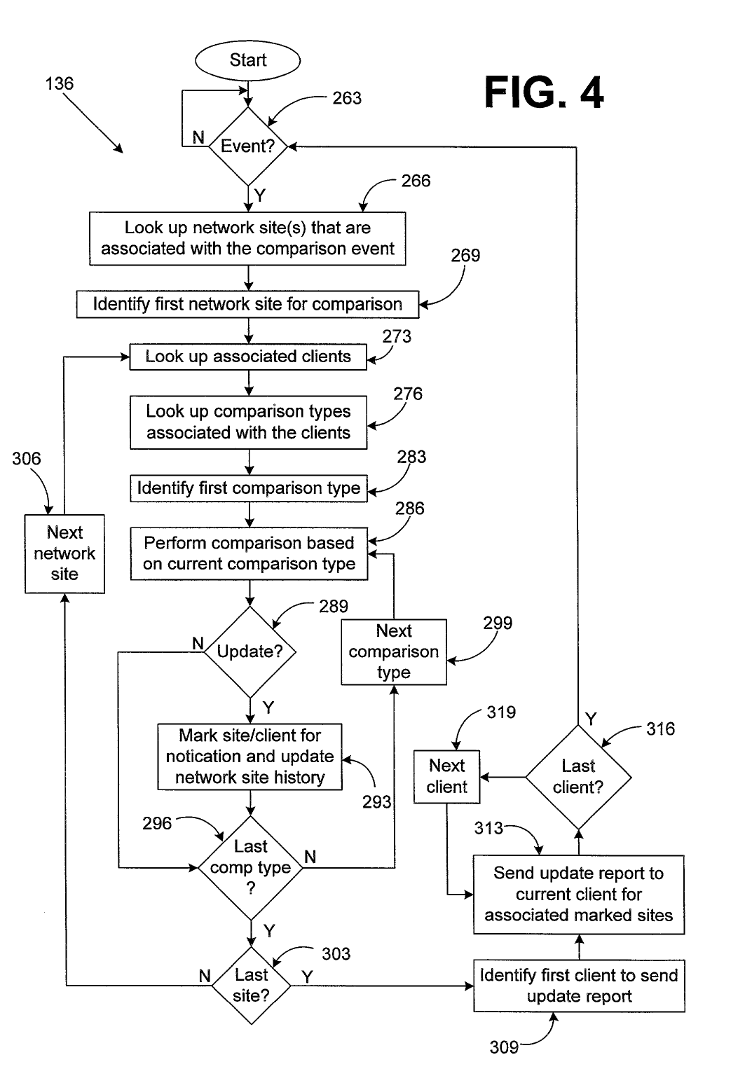

Turning then to FIG. 4, shown is a flow chart of an operational aspect of the update detection system 136 according to an aspect of the present invention. Alternatively, the flow chart of FIG. 4 may be viewed as depicting steps in a method implemented in the update detection server 103. In the case that the update detection system 136 is implemented in terms of software executable by the processor 123 and stored on the memory 126, several different programming languages may be employed, including, for example, C++, Java, JavaScript, or other proprietary scripting and programming languages native to the Update Detection Server 103. As stated previously, the update detection system 136 is executed to detect updates in various network sites 203 (FIG. 1) for multiple clients 106 (FIG. 1).

Beginning with block 263, the update detection system 136 first determines whether a comparison event 239 (FIG. 2) has occurred. If such is the case then the update detection system 136 proceeds to block 266 in which all network sites 203 (FIG. 1) that are associated with the comparison event 239 are looked up from the site update database 139 (FIG. 1). Thereafter, in block 269 the first network site 203 of those looked up in block 266 is identified for further processing. Next, in block 273, those clients 106 (FIG. 1) that are associated with the current identified network site 203 are looked up from the site update database 139. Thereafter, in block 276 the comparison types 223 that are associated with each of these clients 106 are looked up from the site update database 139 as well. This is because various clients 106 may wish to have the network site 203 examined using a different approach as was described previously to detect updates or changes.

Next, in block 283 the update detection system 136 identifies a first comparison type to perform on the network site 203. Then, in block 286, a comparison is performed for the network site 203 based upon the current comparison type. Specifically, the network site 203 is downloaded from the second server 109 to the update detection server 103 and the update detection system 136 generates a checksum or other value representative of the content of the network site 203 as was discussed previously. This checksum or other value is then compared with a prior checksum that was stored in the memory 126 having been obtained the last time that the comparison event 239 occurred. Then, in block 289 if an update is detected due to a difference in the checksums, for example, then the update detection system 136 proceeds to block 293. Otherwise, the update detection system 136 proceeds to block 296.

In block 293, the newly updated network site 203 and the client 106 associated therewith are marked in the site update database 139 with an appropriate value or other indication. This is done to inform the update detection system 136 that such network site 203 has been changed and that such client 106 should be informed of the change. Thereafter, the update detection system 136 moves to block 269 in which it is determined whether the last comparison type of all those identified in block 276 has been performed in block 286. If not, then the update detection system 136 moves to block 299 in which the next comparison type identified in block 276 is chosen for further processing. Thereafter, the update detection system 136 reverts back to block 286.

On the other hand, assuming that the last comparison type has been performed in block 286, then the update detection system proceeds to block 303. In block 303 it is determined whether the last network site 203 that is associated with current comparison event 239 detected in block 263 has been examined for an existence of an update. If further network sites 203 remain, then the update detection system 136 proceeds to block 306 in which the next network site 203 is chosen out of those looked up in block 266. Thereafter, update detection system 136 reverts back to block 273.

Assuming, however, that all of the network sites 203 have been examined for updates, then from block 303 the update detection system 136 proceeds to block 309 in which the first client 106 that was marked in block 293 is identified. Thereafter, in block 313, the update detection system 136 generates the update report 209 (FIG. 1) for the identified client 106 and transmits the update report 209 to the client 106. Specifically, the update report 209 may be embodied within an electronic mail message, for example, that is transmitted to the client 106 via a predefined address on the network 113 (FIG. 1). Alternatively, the update report 209 may be posted to a network site in the update detection server 103 (FIG. 1), for example, and is downloaded to the client 106 when the user accesses such a network site using the browser 176. In addition, other approaches may be employed to transmit the update report 209 to the client 106.

Next, in block 316 the update detection system 136 determines whether there are any more clients 106 that have been marked to receive an update report 209 in the site update database 139. If there are any remaining marked clients 106 in the site update database 139, then the update detection system 139 proceeds to block 319 in which the next marked client 106 is selected for further processing. Thereafter, the update detection system 136 reverts back to block 313 in order to send an update report 209 to the newly identified client. However, assuming that there are no more remaining marked clients 106 in the site update database 139 in block 316, then the update detection system 136 reverts back to block 263 to detect the occurrence of additional comparison events 239.

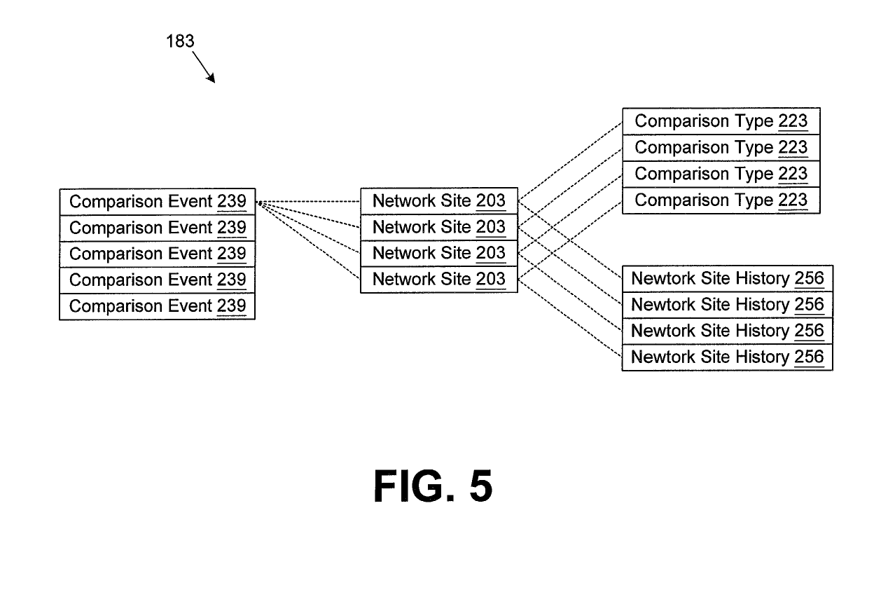

With reference to FIG. 5, shown is an association chart of various fields stored in the site update database 183 according to another aspect of the present invention. Since the update detection system 179 (FIG. 1) is executed in a single client 106 (FIG. 1), then there is no need to track the network sites 203 (FIG. 1) for multiple clients 106. As shown, the comparison events 239 are associated with one or more network sites 203 that are to be monitored by the client 106. Each of the network sites 203 is associated with a comparison type 223 and each of the network sites 203 is also associated with a corresponding network site history 256. Note that the same comparison type 223 may be associated with any number of the network sites 203, although a one to one correspondence is shown in FIG. 5.

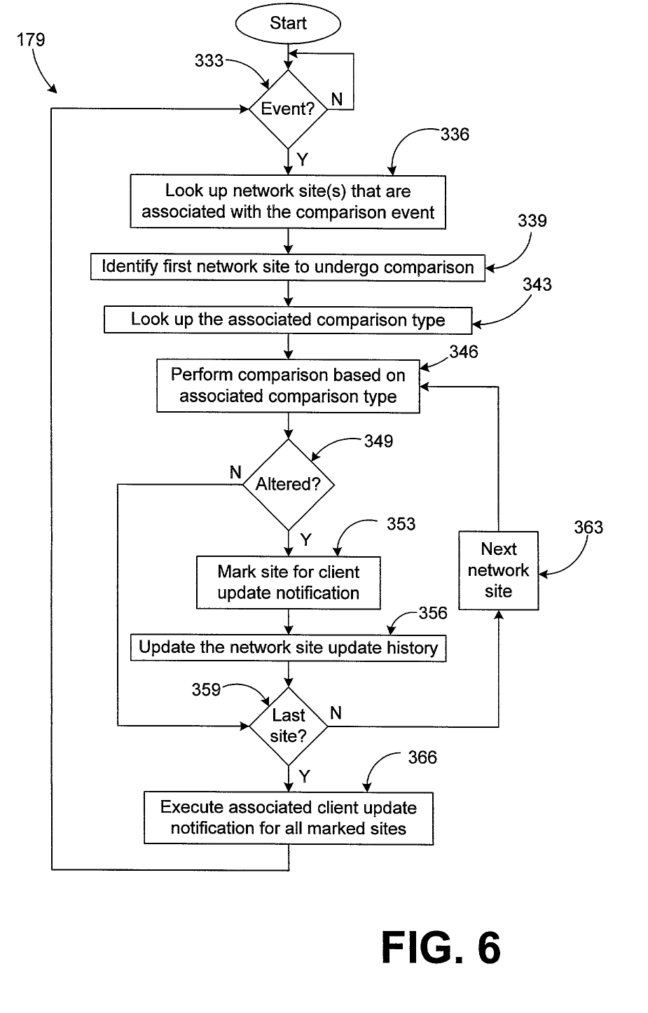

With reference to FIG. 6, shown is a flow chart of the operation of the update detection system 179 according to an aspect of the present invention. Alternatively, the flow chart of FIG. 6 may be viewed as depicting the steps in a method executed in the client 106. Where the update detection system 179 is implemented in terms of software executable by the processor 143 (FIG. 1) and stored on the memory 146 (FIG. 1), then the update detection system 179 may be programmed in one of several languages as described with reference to the update detection system 136 (FIG. 4).

Beginning with block 333, the update detection system 179 determines whether a comparison event 239 (FIG. 5) has occurred. If such is the case, then the update detection system 179 proceeds to block 336 in which the network sites 203 that are associated with the recently occurred comparison event 239 are looked up from the site update database 183. Thereafter, in block 339, a first one of the network sites 203 that was looked up is identified to undergo a comparison. Thereafter, in block 343 the comparison type 223 that is associated with the network site 203 is looked up in the site update database 183.

Next, in block 346 a comparison is performed based on the associated comparison type 223 to determine an existence of an update in the identified network site 203. This may be done, for example, by downloading the network site 203 into the memory 146 of the client 106 and then comparing a measurement of the content of the that network site 203 with a checksum of for that network site 203 that was generated on a previous occasion. Thus, the comparison to determine whether an update has occurred to a particular network site 203 is performed in a similar manner to the comparisons performed by the update detection system 136.

In block 349, the update detection system 179 determines whether an alteration has occurred to the current network site 203 under scrutiny. If so then the update detection system 179 proceeds to block 353 in which the network site 203 is marked in the site update database 183 for notification to the client 106. Thereafter, in block 356 the network site history 256 associated with the current network site 203 is updated to indicate the detected update. The update detection system 179 then proceeds to block 359 and which it is determined whether the current network site 203 under consideration is the last network site 203 looked up in block 336. Also, if there were no alterations to the network site 203 in block 349 as described above, then the update detection system 179 proceeds directly to block 359.

Assuming that there are further network sites 203 remaining that should be examined for updates in block 359, then the update detection system 179 proceeds to block 363 in which the next network site 203 identified in block 336 is identified. Thereafter, the update detection system 179 reverts back to block 346 to perform the comparison with the newly identified network site 203.

Assuming that the current network site 203 under consideration in block 359 is the last network site 203 of those identified in block 336, then the update detection system 179 proceeds to block 366 in which the user is notified of the updates to all the respective network sites 203 that were marked in block 353 with an appropriate user interface. Thereafter, the update detection system 179 reverts back to block 333 to detect further occurrences of additional comparison events 239.

Although the update detection systems 136 and 179 of the present invention are embodied in software executed by general purpose hardware as discussed above, as an alternative the update detection systems 136 and 179 may also be embodied in dedicated hardware or a combination of software/general purpose hardware and dedicated hardware. If embodied in dedicated hardware, the update detection systems 136 and 179 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 4 and 6 show the architecture, functionality, and operation of an implementation of the update detection systems 136 and 179. If embodied in software, each block may represent a module, segment, or portion of code that comprises one or more action statements in the form of executable instructions or declarations to implement the specified logical function(s). If embodied in hardware, each block may represent a circuit or a number of interconnected circuits to implement the specified logical function(s). Although the flow charts of FIGS. 4 and 6 show a specific order of execution, it is understood that the order of execution may differ from that which is depicted. For example, the order of execution of two or more blocks may be scrambled relative to the order shown. Also, two or more blocks shown in succession in FIGS. 4 and 6 may be executed concurrently or with partial concurrence. It is understood that all such variations are within the scope of the present invention. Also, the flow charts of FIGS. 4 and 6 are relatively self-explanatory and are understood by those with ordinary skill in the art to the extent that software and/or hardware can be created by one with ordinary skill in the art to carry out the various logical functions as described herein.

Also, the update detection systems 136 and 179 can be embodied in any computer-readable medium for use by or in connection with an instruction execution system such as a computer/processor based system or other system that can fetch or obtain the logic from the computer-readable medium and execute the action statements including the instructions contained therein. In the context of this document, a “computer-readable medium” can be any medium that can contain, store, or maintain the update detection systems 136 and 179 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact disks. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/we claim:

1. A network update tracking system in a server, comprising:
a processor circuit having a processor and a memory;
update detection logic stored on the memory and executable by the processor, the update detection logic comprising:
logic that detects a number of updates in a corresponding number of network sites; and
logic that generates an update report to be sent to a client via a network, the update report listing at least one of the updates.

2. The system of claim 1, wherein the update detection logic further comprises logic that transmits the update report to the client via the network.

3. The network update tracking system of claim 1, wherein the update detection logic further comprises logic that posts the update report to a network site accessible by a user via the client through the network.

4. The system of claim 1, wherein the logic that detects the number of updates in the corresponding number of network sites further comprises logic that compares a content measure of at least one of the network sites with a corresponding previous content measure upon an occurrence of a comparison event.

5. The network update tracking system of claim 2,
wherein the logic that generates the update report to be sent to the client via the network further comprises logic that embodies the update report into an electronic mail message; and
wherein the logic that transmits the update report to the client via the network further comprises logic that transmits the electronic mail message to the client via the network.

6. The system of claim 4, wherein the logic that detects the number of updates in the corresponding number of network sites further comprises logic that detects the occurrence of the comparison event.

7. A network update tracking method, comprising:
detecting a number of updates in a corresponding number of network sites in an update detection server; and
generating an update report in the update detection server, the update report to be sent to a client via a network, the update report listing at least one of the updates.

8. The network update tracking method of claim 7, further comprising transmitting the update report to the client via the network.

9. The network update tracking method of claim 8,
wherein the step of generating the update report in the update detection server further comprises embodying the update report into an electronic mail message; and
wherein the step of transmitting the update report to the client via the network further comprises transmitting the electronic mail message to the client via the network.

10. The network update tracking method of claim 7, further comprising posting the update report to a posting network site that is accessible by a user via the client.

11. The network update tracking method of claim 7, wherein the step of detecting the number of updates in the corresponding number of network sites in the update detection server further comprises comparing a content measure of at least one of the network sites with a corresponding previous content measure upon an occurrence of a comparison event.

12. The network update tracking method of claim 11, wherein the step of detecting the number of updates in the corresponding number of network sites in the update detection server further comprises further comprises detecting the occurrence of the comparison event.

13. A network update tracking system, comprising:
a processor circuit having a processor and a memory;
update detection logic stored on the memory and executable by the processor, the update detection logic comprising:
logic that detects at least one update in a network site;
logic that generates an update report, the update report identifying the at least one update; and
logic that presents the update report to a user.

14. The network update tracking system of claim 13, wherein the logic that presents the update report to the user further comprises logic that displays the update report in a graphical user interface on a display device.

15. The network update tracking system of claim 13, wherein the logic that detects the at least one update in the network site in the computer system further comprises logic that compares a content measure of the network site with a previous content measure of the network site upon an occurrence of a comparison event.

16. The network update tracking system of claim 15, wherein the logic that detects the at least one update in the network site in the computer system further comprises logic that detects the occurrence of the comparison event.

17. A network update tracking method, comprising:
detecting at least one update in a network site in a computer system coupled to a network; and
generating an update report in the computer system, the update report identifying the at least one update; and
presenting the update report to a user.

18. The network update tracking method of claim 17, wherein the step of presenting the update report to the user further comprises displaying the update report in a graphical user interface on a display device.

19. The network update tracking method of claim 17, wherein the step of detecting the at least one update in the network site in the computer system further comprises comparing a content measure of the network site with a previous content measure of the network site upon an occurrence of a comparison event.

20. The network update tracking method of claim 19, wherein the step of detecting the at least one update in the network site in the computer system further comprises detecting the occurrence of the comparison event.
